(19) United States
(12) Patent Application Publication
(10) Pub. No.: US 2021/0276265 A1
(43) Pub. Date: Sep. 9, 2021

(54) 3D OBJECT FABRICATION CONTROL BASED ON 3D DEFORMATION MAPS

(71) Applicants: OREGON STATE UNIVERSITY, Corvallis, OR (US); HEWLETT-PACKARD DEVELOPMENT COMPANY, L.P., Spring, TX (US)

(72) Inventors: Daniel MOSHER, Corvallis, OR (US); David A. CHAMPION, Corvallis, OR (US); Brian BAY, Corvallis, OR (US)

(73) Assignees: Oregon State University, Corvallis, OR (US); Hewlett-Packard Development Company, L.P., Spring, TX (US)

(21) Appl. No.: 16/608,378

(22) PCT Filed: Mar. 23, 2018
(86) PCT No.: PCT/US2018/024178

§ 371 Date: Oct. 25, 2019

(51) Int. Cl. B29C 64/393; B29C 64/153; B29C 64/218; B33Y 10/00; B33Y 30/00; B33Y 50/02

(52) U.S. Cl. CPC B29C 64/393; B29C 64/153; B33Y 50/02; B33Y 10/00; B33Y 30/00; B29C 64/218

(57) ABSTRACT

According to examples, an apparatus may include a processor and a memory on which is stored machine readable instructions. The processor may execute the instructions to access a first stereoscopic three-dimensional (3D) image of a surface of a layer of build material particles and a second stereoscopic 3D image of the layer surface, the second stereoscopic 3D image being captured at a later time than the first stereoscopic 3D image. The processor may also generate a 3D deformation map of the layer surface from the first stereoscopic 3D image and the second stereoscopic 3D image and may implement an action based on the generated 3D deformation map of the layer surface.

### BACKGROUND

In three-dimensional (3D) printing, an additive printing process may be used to make three-dimensional solid parts from a digital model. Some 3D printing techniques are considered additive processes because they involve the application of successive layers or volumes of a build material, such as a powder or powder-like build material, to an existing surface (or previous layer). 3D printing often includes solidification of the build material, which for some materials may be accomplished through use of heat and/or a chemical binder.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus that may implement an action based on a 3D deformation map of a layer of build material particles;

FIG. 2 shows a diagram of an example 3D fabrication system in which the apparatus depicted in FIG. 1 may be implemented;

FIGS. 3A and 3B, respectively, show diagrams of example stereoscopic 3D images;

FIG. 3C shows a diagram of an example 3D deformation map generated from the stereoscopic 3D images depicted in FIGS. 3A and 3B; and

FIG. 4 shows a flow diagram of an example method for implementing an action based on a 3D deformation map of a layer of build material particles.

### DETAILED DESCRIPTION

Disclosed herein are apparatuses, 3D fabrication systems, and methods that may implement an action based on a 3D deformation map of a layer of build material particles. That is, the apparatuses, 3D fabrication systems, and methods disclosed herein may generate a 3D deformation map from stereoscopic images and the generated 3D deformation map may be used to determine a characteristic of a layer of build material particles. For instance, a processor may analyze the generated 3D deformation map to determine whether the layer includes any areas that are taller or shorter than intended, whether the layer underwent an improper or abnormal densification or solidification process, or the like. In some examples, in making these determinations, the processor may access additional measurements, such as temperature measurements of the layer. Based on a determination from the 3D deformation map that the layer includes areas having abnormal or unintended characteristics, the processor may implement an action, e.g., issue an alert, stop a fabrication process, modify the fabrication process for the current or a subsequent layer, or the like.

According to examples, the stereoscopic 3D images used to generate the 3D deformation map may be generated using images of a layer of build material particles prior to and/or after application of a solidification and/or binding operation on the build material particles. In these examples, the 3D deformation map may show how a particular layer changed over time. In addition or in other examples, the stereoscopic 3D images may be generated using images of a first layer and a second layer adjacent the first layer. In these examples, the 3D deformation map may show how the second layer has changed with respect to the first layer.

Through implementation of the apparatuses, 3D fabrication systems, and methods disclosed herein, a processor may generate high resolution 3D deformation maps from high resolution stereoscopic 3D images. As the high resolution 3D deformation maps may identify fine detail, e.g., the processor may determine with a high degree of accuracy, whether anomalies or defects exist on a surface of a layer of build material particles. In addition, based on a determination that an anomaly or defect exists, the processor may implement an action to inform an operator of the potential issue and/or modify a fabrication process. In one example, the processor may modify the fabrication process to compensate for the anomaly or defect, correct the anomaly or defect, and/or prevent the anomaly or defect from occurring in a next layer. In one example, the processor may stop the fabrication process based on a determination that the anomaly or defect exists to prevent the fabrication of defective 3D objects. As build material particles may be relatively expensive, stopping the fabrication of defective 3D object as early as possible may reduce or minimize wasted build material particles, which may also reduce costs.

Before continuing, it is noted that as used herein, the terms “includes” and “including” mean, but is not limited to, “includes” or “including” and “includes at least” or “including at least.” The term “based on” means “based on” and “based at least in part on.”

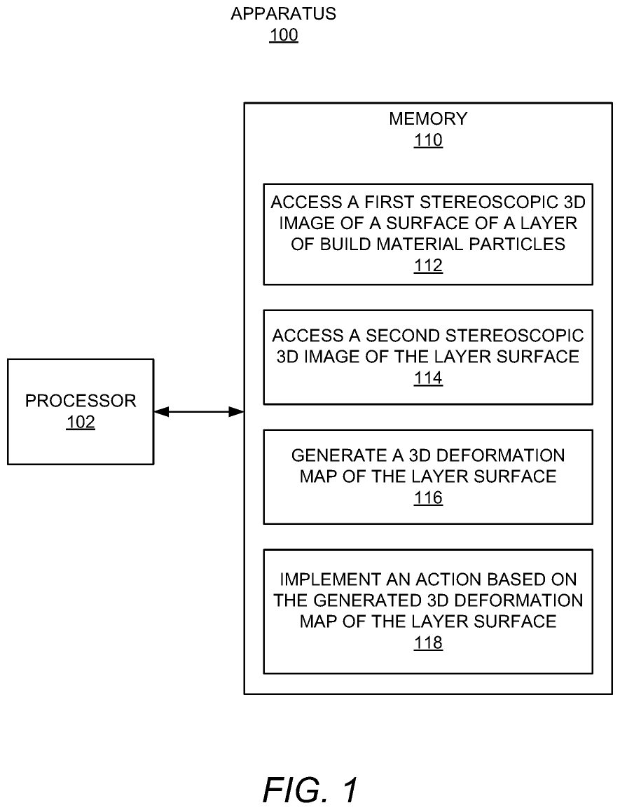

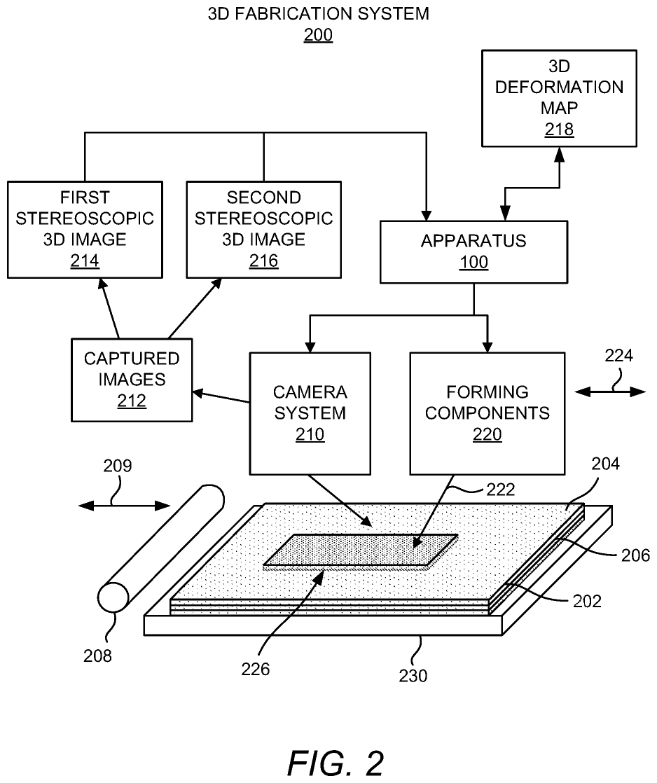

Reference is made first to FIGS. 1 and 2. FIG. 1 shows a block diagram of an example apparatus 100 that may implement an action based on a 3D deformation map of a layer of build material particles. FIG. 2 shows a diagram of an example 3D fabrication system 200 in which the apparatus 100 depicted in FIG. 1 may be implemented. It should be understood that the example apparatus 100 depicted in FIG. 1 and the example 3D fabrication system 200 depicted in FIG. 2 may include additional features and that some of the features described herein may be removed and/or modified without departing from the scopes of the apparatus 100 or the 3D fabrication system 200.

Generally speaking, the apparatus 100 may be a computing device, such as a personal computer, a laptop computer, a tablet computer, a smartphone, a server computer, or the like. In addition or in other examples, the apparatus 100 may be control system of the 3D fabrication system 200. Although a single processor 102 is depicted, it should be understood that the apparatus 100 may include multiple processors, multiple cores, or the like, without departing from a scope of the apparatus 100.

The 3D fabrication system 200, which may also be termed a 3D printing system, a 3D fabricator, or the like, may be implemented to fabricate 3D objects through selective solidification and/or binding of build material particles 202, which may also be termed particles 202 of build material. In some examples, the 3D fabrication system 200 may use energy, e.g., in the form of light and/or heat, to selectively fuse the particles 202. In addition or in other examples, the 3D fabrication system 200 may use binding agents to selectively bind or join the particles 202. In particular examples, the 3D fabrication system 200 may use fusing agents that increase the absorption of energy to selectively fuse the particles 202 together.

According to one example, a suitable fusing agent may be an ink-type formulation including carbon black, such as, for example, the fusing agent formulation commercially known as V1Q60Q “HP fusing agent” available from HP Inc. In one example, such a fusing agent may additionally include an infra-red light absorber. In one example such fusing agent may additionally include a near infra-red light absorber. In one example, such a fusing agent may additionally include a visible light absorber. In one example, such a fusing agent may additionally include a UV light absorber. Examples of fusing agents including visible light enhancers are dye based colored ink and pigment based colored ink, such as inks commercially known as CE039A and CE042A available from HP Inc. According to one example, the 3D fabrication system 200 may additionally use a detailing agent. According to one example, a suitable detailing agent may be a formulation commercially known as V1Q61A “HP detailing agent” available from HP Inc.

The build material particles 202 may include any suitable material for use in forming 3D objects. The build material particles may include, for instance, a polymer, a plastic, a ceramic, a nylon, a metal, combinations thereof, or the like, and may be in the form of a powder or a powder-like material. Additionally, the build material particles 202 may be formed to have dimensions, e.g., widths, diameters, or the like, that are generally between about 5 μm and about 100 μm. In other examples, the particles 202 may have dimensions that are generally between about 30 μm and about 60 μm. The particles 202 may have any of multiple shapes, for instance, as a result of larger particles being ground into smaller particles. In some examples, the particles 202 may be formed from, or may include, short fibers that may, for example, have been cut into short lengths from long strands or threads of material. In addition or in other examples, the particles may be partially transparent or opaque. According to one example, a suitable build material may be PA12 build material commercially known as V1 R10A “HP PA12” available from HP Inc.

As shown in FIG. 1, the apparatus 100 may include a processor 102 that may control operations of the apparatus 100. The processor 102 may be a semiconductor-based microprocessor, a central processing unit (CPU), an application specific integrated circuit (ASIC), a field-programmable gate array (FPGA), and/or other suitable hardware device. The apparatus 100 may also include a memory 110 that may have stored thereon machine readable instructions 112-118 (which may also be termed computer readable instructions) that the processor 102 may execute. The memory 110 may be an electronic, magnetic, optical, or other physical storage device that contains or stores executable instructions. The memory 110 may be, for example, Random Access memory (RAM), an Electrically Erasable Programmable Read-Only Memory (EEPROM), a storage device, an optical disc, and the like. The memory 110, which may also be referred to as a computer readable storage medium, may be a non-transitory machine-readable storage medium, where the term “non-transitory” does not encompass transitory propagating signals.

The processor 102 may fetch, decode, and execute the instructions 112 to access a first stereoscopic 3D image 214 of a surface 204 of a layer 206 of build material particles 202. The 3D fabrication system 200 may include a spreader 208 that may spread the build material particles 202 into the layer 206, e.g., through movement across a platform 230 as indicated by the arrow 209. A stereoscopic 3D image 214 may be created from two offset images of the layer surface 204 to give the perception of 3D depth. As shown in FIG. 2, the 3D fabrication system 200 may include a camera system 210 to capture the offset images. The camera system 210 may include a single camera or multiple cameras positioned at different angles with respect to each other such that multiple ones of the captured images may be combined to generate stereoscopic 3D images. According to examples, the camera system 210 may capture high-resolution images, e.g., high definition quality, 4K resolution quality, or the like, such that the stereoscopic 3D images generated from images captured by the camera system 210 may also be of high resolution. In addition, the 3D fabrication system 200 may include a light source (not shown) to illuminate the layer surface 204 and enable the camera system 210 to capture fine details in the layer surface 204. For instance, the camera system 210 may capture images of sufficient resolution to enable individual build material particles 202 to be identified in the images.

The processor 102 may control the camera system 210 to capture multiple images 212 of the layer surface 204 and the first stereoscopic 3D image 214 may be generated from the multiple captured images 212. For instance, the camera system 210 may have been controlled to capture a first image of the layer surface 204 from a first angle with respect to the layer surface 204 and may have captured a second image of the layer surface 204 from a second, offset, angle with respect to the layer surface 204. In addition, the first image may have been combined with the second image to create the first stereoscopic 3D image 214. In some examples, a first camera of the camera system 210 may have captured the first image and a second camera of the camera system 210 may have captured the second image. In other examples, a single camera of the camera system 210 may have captured the first image and may have been moved or otherwise manipulated, e.g., through use of mirrors and/or lenses, to capture the second image.

The camera system 210 may generate the first stereoscopic 3D image 214 from the multiple captured images and may communicate the generated first stereoscopic 3D image 214 to the processor 102 or to a data store from which the processor 102 may access the first stereoscopic 3D image 214 of the layer surface 204. In other examples, the camera system 210 may store the captured images in a data store (not shown) and the processor 102 may generate the stereoscopic 3D image 214 of the layer surface 204 from the stored images.

As also shown in FIG. 2, the 3D fabrication system 200 may include forming components 220 that may output energy and/or agent 222 onto the layer 206 as the forming components 220 are scanned across the layer 206 as denoted by the arrow 224. The forming components 220 may also be scanned in the direction perpendicular to the arrow 224 or in other directions. In addition, or alternatively, a platform 230 on which the layers 206 are deposited may be scanned in directions with respect to the forming components 220.

The forming components 220 may include various components to solidify and/or bind the build material particles 202 in a selected area 226 of the layer 206. The selected area 226 of a layer 206 may correspond to a section of a 3D object being fabricated in multiple layers 206 of the build material particles 202. The forming components 220 may include, for instance, an energy source, e.g., a laser beam source, a heating lamp, or the like, that may apply energy onto the layer 206 and/or that may apply energy onto the selected area 226. In addition or alternatively, the forming components 220 may include a fusing agent delivery device to selectively deliver a fusing agent onto the build material particles 202 in the selected area 226, in which the fusing agent enhances absorption of the energy to cause the build material particles 202 upon which the fusing agent has been deposited to melt. The fusing agent may be applied to the build material particles 202 prior to application of energy onto the build material particles 202. In other examples, the forming components 220 may include a binding agent delivery device that may deposit a binding agent, such as an adhesive that may bind build material particles 202 upon which the binding agent is deposited. According to examples, the binding agent may be thermally curable, UV curable, or the like.

The solidified build material particles 202 may equivalently be termed fused build material particles, bound build material particles, or the like. In any regard, the solidified build material particles 202 may be a part of a 3D object, and the 3D object may be built through selective solidification of the build material particles 202 in multiple layers 206 of the build material particles 202.

In some examples, the captured images 212 used to create the first stereoscopic 3D image 214 may have been captured prior to a solidification operation being performed on the layer 206 of build material particles 202 through operation of the forming components 220. In other examples, the captured images 212 used to create the first stereoscopic 3D image 214 may have been captured following a solidification operation being performed on the layer 206. In these examples, the first stereoscopic 3D image 214 may have been created from images 212 that include both build material particles 202 in the selected area 226 of the layer 206 that have been joined together and build material particles 202 that have not been joined together. In still other examples, the camera system 210 may continuously capture images, e.g., video, and the continuously captured images may be used to continuously create multiple stereoscopic 3D images, e.g., video.

The processor 102 may fetch, decode, and execute the instructions 114 to access a second stereoscopic 3D image 216 of the layer surface 206. The second stereoscopic 3D image 216 may have been generated from images 212 that have been captured at a later time than the images 212 used to generate the first stereoscopic 3D image 214. For instance, the images 212 used to create the first stereoscopic 3D image 214 may have been captured prior to a joining operation being performed on the layer 206 and the images 212 used to create the second stereoscopic 3D image 216 may have been captured following the joining operation being performed on the layer 206. In other examples, the images 212 used to create the first stereoscopic 3D image 214 may have been captured at a first time following performance of the joining operation on the layer 206 and the images 212 used to create the second stereoscopic 3D image 216 may have been captured at a time following the capture of the images 212 used to create the first stereoscopic 3D image 214.

By way of particular example, the images 212 used to create both the first stereoscopic 3D image 214 and the second stereoscopic 3D image 216 may have been captured during a cooling phase of the layer 206 following a joining operation in which energy 222 is used to fuse the build material particles 202 in the selected area 226. That is, the images 212 used to create the first stereoscopic 3D image 214 may have been captured at a first time (t1) following application of energy 222 onto the layer 206 and the images 212 used to create the second stereoscopic 3D image 216 may have been captured at a second time (t2) following application of energy 222 onto the layer 206. In one regard, therefore, changes in the height and/or the density of the build material particles 202 in the layer 206 as the joined build material particles 202 cool may be determined through a comparison of the second stereoscopic 3D image 216 and the first stereoscopic 3D image 214. The processor 102 may access additional measurements, such as temperature measurements of the layer, in determining the density of the build material particles 202 in the layer 206.

The processor 102 may fetch, decode, and execute the instructions 116 to generate a 3D deformation map 218 of the layer surface 204. The processor 102 may generate the 3D deformation map 218 of the layer surface 204 from the first stereoscopic 3D image 214 and the second stereoscopic 3D image 216. The 3D deformation map 218 of the layer surface 204 may depict how the layer surface 204 has deformed or has changed over time, e.g., from when the images 212 used to generate the first stereoscopic 3D image 214 were captured to when the images 212 used to generate the second stereoscopic 3D image 216 were captured. In this regard, the processor 102 may generate the 3D deformation map 218 of the layer surface 204 from a comparison of information depicted in the second stereoscopic 3D image 216 and information depicted in the first stereoscopic 3D image 214. In some examples, the information may include, for instance, heights of the build material particles 202 throughout the layer surface 204. In these examples, the 3D deformation map 218 may depict changes in height of the build material particles 202 between the first stereoscopic 3D image 214 and the second stereoscopic 3D image 216. In addition, the 3D deformation map 218 may depict an amount of build material particle 202 densification experienced during a joining operation, e.g., a fusing operation.

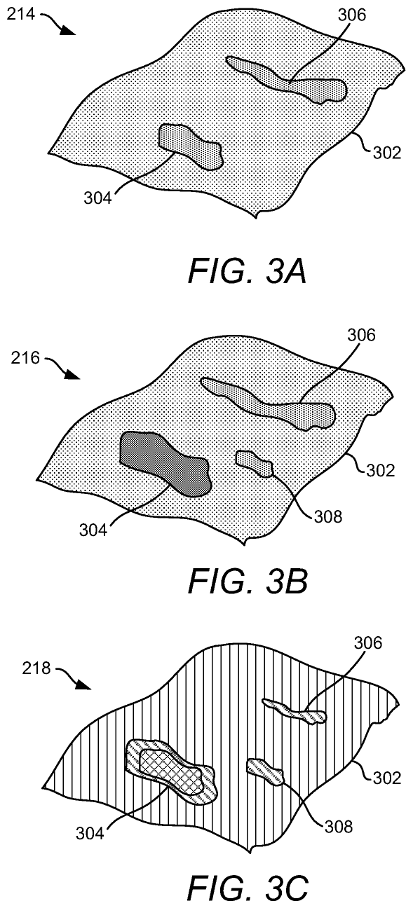

An example of a manner in which the processor 102 may generate the 3D deformation map 218 of the surface layer 204 is depicted in FIGS. 3A-3C. Particularly, FIG. 3A depicts an example first stereoscopic 3D image 214, FIG. 3B depicts an example second stereoscopic 3D image 216, and FIG. 3C depicts an example 3D deformation map 218 generated from the first stereoscopic 3D image 214 and the second stereoscopic 3D image 216. It should be understood that FIGS. 3A-3C merely depict examples and should thus not be construed as limiting the present disclosure to the features depicted in those figures. In addition, although particular reference made herein to the 3D deformation map being generated from two stereoscopic images, it should be understood that the 3D deformation map may be generated using a larger number of stereoscopic images.

In FIGS. 3A-3C, different heights of the surface layer 204 may be depicted in different shadings (e.g., different colors). Thus, for instance, a first shading may represent a first height, a second shading may represent a second height, and so forth. As shown in FIG. 3A, the first stereoscopic 3D image 214 may display a first area 302 of the layer surface 204 as having the first height and may display a second area 304 and a third area 306 of the layer surface 204 as having the second height. As shown in FIG. 3B, the second stereoscopic 3D image 216 may display the first area 302 as having the first height and the third area 306 as having the second height. However, the second stereoscopic 3D image 216 may display the second area 304 as having the second height and may display a fourth area 308 as having the second height.

In comparing the second stereoscopic 3D image 216 with the first stereoscopic 3D image 214, the processor 102 may determine that the first area 302 and the third area 306 have not substantially changed and that the second area 304 and the fourth area 308 have changed. As such, the processor 102 may generate the 3D deformation map 218 to show the changes in height between the second stereoscopic 3D image 216 and the first stereoscopic 3D image 214 from the time the images 212 used to generate the first stereoscopic 3D image 214 were captured and the time the images 212 used to generate the second stereoscopic 3D image 216 were was captured.

In this regard, the 3D deformation map 218 shown in FIG. 3C may depict the first area 302 as not being deformed, e.g., changed, and may thus depict the first area 302 with a first color. In addition, the 3D deformation map 218 may depict the second area 304 with a second color and a third color to depict that portions of the second area 304 have undergone different levels of deformation. The 3D deformation map 218 may also depict the third area 306 with a relatively smaller section of the second color as compared to the third areas 306 and the first and second stereoscopic 3D images 214, 216 to indicate that the third area 306 has undergone a relatively small deformation. Moreover, the 3D deformation map 218 may depict the fourth area 308 with the second color to indicate that the fourth area 308 has undergone a particular height change.

With reference back to FIG. 1, the processor 102 may fetch, decode, and execute the instructions 118 to implement an action based on the generated 3D deformation map 218 of the layer surface 204. The processor 102 may analyze the 3D deformation map 218 to identify anomalies, defects, deformations, or the like, in the layer 206. That is, the processor 102 may determine from the 3D deformation map 218 whether certain areas of the layer surface 204 have undergone deformations and/or changes that exceed a predefined threshold. By way of example, the processor 102 may determine whether the build material particles 202 in a certain area are at a height that exceeds a predefined threshold height, which may be an indication that a bubble or other defect, e.g., a densification issue, may exist in the layer 206 in the certain area.

Based on a determination that the 3D deformation map 218 indicates that an anomaly or a defect exists in the layer 206, the processor 102 may implement an action, e.g., the processor 102 output an instruction to perform the action. However, in other examples, the processor 102 may determine whether a defective area exists in a portion of the layer 206 that forms part of the 3D object being generated and may implement the action in response to the defective area existing in a portion of the layer 206 that forms part of the 3D object being generated. In any event, the processor 102 may implement an action in which the processor 102 may output an alert, such as an alert message on a display device, an error indicator light to be lit, an audible alarm being outputted, or the like. In addition or in other examples, the processor 102 may implement an action in which the processor 102 may modify a forming operation on a current layer 206 or a subsequently deposited layer 206 of build material particles 202. The processor 102 may modify the fabrication process to compensate for the anomaly or defect, correct the anomaly or defect, and/or prevent the anomaly or defect from occurring in a next layer. For instance, the processor 102 may perform a remediative action, such as, spreading another layer of build material particles 202 on the current layer 206, applying additional energy during solidification of the next layer (if a previous layer was not sufficiently fused, etc.), applying additional fusing agent in a subsequent layer, etc. The processor 102 may also generate a 3D deformation map following performance of the remediative action to determine whether the remediative action was sufficient. If not, the processor 102 may perform another remediative action.

As a further example, the processor 102 may implement an action in which the processor 102 may stop a current forming operation of a 3D object, e.g., may cease deposition of a binding agent on the current layer 206, may cease application of fusing energy onto the current layer 206, or the like. As a yet further example, the processor 102 may count a number of defective areas (or determine a density of the defective areas) within the current layer 206 or a portion of the current layer 206 and may determine whether the 3D object being generated is of sufficient quality. The sufficient quality may be based upon, for instance, a quality level set for the 3D object such as, draft, production, or the like. In addition, the processor 102 may compare the count or density of the defective areas against a threshold (e.g., which may depend on the set quality level) and may determine whether to stop production of the 3D object based on the comparison. In addition or alternatively, the processor 102 may output an indication concerning the comparison such that an operator may decide whether to stop production.

According to examples, the processor 102 may have the option to perform any of the above-cited actions or a combination of the above-cited actions. In these examples, the processor 102 may select one of the actions based upon the severity of the detected anomaly or deformity. For instance, the processor 102 may select a first option in response to a detected deformity exceeding a first predefined threshold level, may select a second option in response to a detected deformity exceeding a second predefined threshold level, may select a third option in response to a detected deformity exceeding a third predefined threshold level, etc. By way of particular example, the processor 102 may stop the forming operation of the 3D object in response to the detected deformity level exceeding the third predefined threshold level. In any regard, the predefined threshold levels may be determined through testing, defined by an operator, defined based upon a selected print quality for the 3D object, or the like.

In other examples, instead of the memory 110, the apparatus 100 may include hardware logic blocks that may perform functions similar to the instructions 112-118. In yet other examples, the apparatus 100 may include a combination of instructions and hardware logic blocks to implement or execute functions corresponding to the instructions 112-118. In any of these examples, the processor 102 may implement the hardware logic blocks and/or execute the instructions 112-118. As discussed herein, the apparatus 100 may also include additional instructions and/or hardware logic blocks such that the processor 102 may execute operations in addition to or in place of those discussed above with respect to FIG. 1.

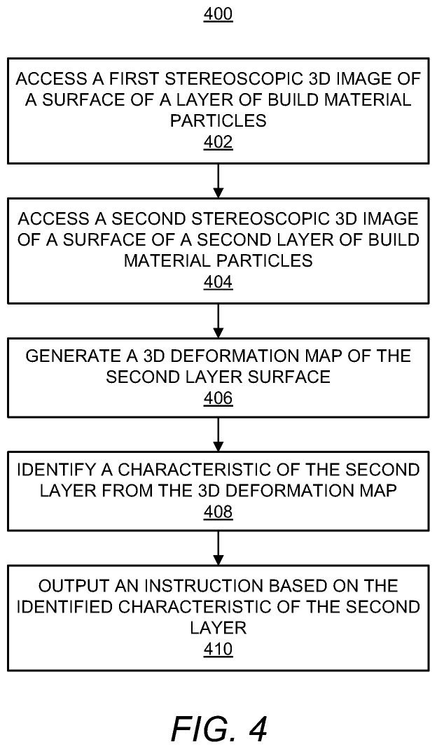

Various manners in which the processor 102 may operate are discussed in greater detail with respect to the method 400 depicted in FIG. 4. Particularly, FIG. 4 depicts a flow diagram of an example method 400 for implementing an action based on a 3D deformation map of a layer of build material particles. It should be understood that the method 400 depicted in FIG. 4 may include additional operations and that some of the operations described therein may be removed and/or modified without departing from scope of the method 400. The description of the method 400 is made with reference to the features depicted in FIGS. 1-3C for purposes of illustration.

At block 402, the processor 102 may access a first stereoscopic 3D image 214 of a surface 204 of a first layer 206 of build material particles 202. As discussed herein, the first stereoscopic 3D image 214 may be generated through a combination of two offset images 212 of the layer surface 204 to give the perception of 3D depth. According to examples, the two offset images 212 used to generate the first stereoscopic 3D image 214 may have been captured following a joining operation being performed on the build material particles 202 in the first layer 206.

At block 404, the processor 102 may access a second stereoscopic 3D image 216 of a surface 204 of a second layer of build material particles 202. As discussed herein, the second stereoscopic 3D image 214 may be generated through a combination of two offset images 212 of the layer surface 204 to give the perception of 3D depth. According to examples, the two offset images 212 used to generate the second stereoscopic 3D image 216 may have been captured following spreading by the spreader 208 of a layer 206 of build material particles 202 on top of the first layer 206. In addition, the two offset images 212 used to generate the second stereoscopic 3D image 216 may have been captured prior to, during, or following performance of a joining operation on the build material particles 202 in the second layer.

At block 406, the processor 102 may generate a 3D deformation map 218 of the second layer surface from the second stereoscopic 3D image 216 and the first stereoscopic 3D image 214. The 3D deformation map 218 of the second layer surface may depict characteristics of the second layer surface. The characteristics may include, for instance, heights at various areas of the second layer surface with respect to corresponding areas of the first layer surface 204. That is, for instance, the processor 102 may subtract a known or nominal height difference between the first layer surface 204 and the second layer surface and may generate the 3D deformation map 218 to show variances from the known or nominal height difference. Thus, for instance, the 3D deformation map 218 may show areas on the second layer surface that may be shallower or higher than intended. The 3D deformation map 218 may represent the heights of the areas on the second layer surface using various colors such that the different heights may readily be distinguished from each other.

At block 408, the processor 102 may identify a characteristic of the second layer from the 3D deformation map 218. The characteristic may be, for instance, a calculated density, an anomaly, a defect, a deformation, or the like. For instance, the processor 102 may identify from the 3D deformation map 218, an area on the second surface layer that is lower than intended. This determination may be made through a comparison of the actual heights of the build material particles 202 in the second surface layer and an intended (or expected) height of the build material particles 202 in the second surface layer. The intended height of the build material particles 202 may be determined from previously formed layers, e.g., the average or nominal height of the build material particles 202 following solidification of the build material particles 202, and/or an expected height of the build material particles 202 in the second surface layer. As the 3D deformation map 218 may be generated from stereographic images, the heights of the build material particles 202 throughout the second surface layer may accurately be determined and in a relatively shorter period of time than through use of laser scanners.

Based on a determination that an area of the second surface layer is lower than intended, the processor 102 may determine that the build material particles 202 beneath the area may be arranged at a density that is higher than intended, may have undergone an improper densification or solidification process, or the like. As another example, the processor 102 may identify from the 3D deformation map 218, an area on the second surface layer that is higher than intended. In this example, the processor 102 may determine that the build material particles 202 beneath the area may be arranged at a density that is lower than intended, may have undergone an improper densification process, that an air bubble may have formed between the build material particles 202, and/or the like. In other examples, the processor 102 may identify from the 3D deformation map 218 that the characteristics of the second layer are within intended levels.

At block 410, the processor 102 may, based on the identified characteristic of the second layer, output an instruction to at least one of issue an alert or modify a forming operation of a 3D object. That is, for instance, the processor 102 may output an instruction to issue an alert, e.g., an audible alert, a visual alert, or both, to output an instruction to stop the forming operation of the 3D object, to output an instruction to modifying the forming operation of the 3D object on at least one of the second layer or a subsequently deposited layer, and/or the like. According to examples, the processor 102 may output one or more of the instructions discussed above based on a severity level of the identified characteristic of the second layer. In examples in which the processor 102 is to output an instruction to modify the forming operation, the processor 102 may output an instruction to the forming components 220 to, for instance, increase or decrease an amount of binding agent delivered, increase or decrease an amount of energy applied to fuse the build material particles 202, or the like.

According to examples, the processor 102 may generate a first 3D deformation map of the first layer surface 204 using sets of images 212 of the first layer surface 204 and may generate a second 3D deformation map of the second layer surface using multiple sets of images 212 of the second layer surface 206. In these examples, the processor 102 may compare the second 3D deformation map of the second layer with the first 3D deformation map of the first layer to identify the characteristic of the second layer. For instance, the processor 102 may generate a third 3D deformation map from the first 3D deformation map and the second 3D deformation map, such that the third 3D deformation map depicts changes between the first 3D deformation map and the second 3D deformation map. Thus, the processor 102 may identify the characteristic of the second layer from the third 3D deformation map.

According to examples, the processor 102 may access a third stereoscopic 3D image of the second layer surface. In these examples, the second stereoscopic 3D image and the third stereoscopic 3D image may have been captured following fusing energy being applied onto the second layer and while the build material particles 202 in the second layer are cooling. In addition, the processor 102 may generate a second 3D deformation map of the second layer surface from the second stereoscopic 3D image and the third stereoscopic 3D image. The second 3D deformation map may depict how the second layer surface has changed during cooling of the second layer. The processor 102 may further identify the characteristic of the second layer from the second 3D deformation map.

Some or all of the operations set forth in the method 400 may be included as utilities, programs, or subprograms, in any desired computer accessible medium. In addition, the method 400 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which is stored machine readable instructions that when executed by the processor are to cause the processor to:
access a first stereoscopic three-dimensional (3D) image of a surface of a layer of build material particles;
access a second stereoscopic 3D image of the layer surface, the second stereoscopic 3D image being captured at a later time than the first stereoscopic 3D image;
generate a 3D deformation map of the layer surface from the first stereoscopic 3D image and the second stereoscopic 3D image; and
implement an action based on the generated 3D deformation map of the layer surface.

2. The apparatus of claim 1, wherein the first stereoscopic 3D image of the layer surface is captured prior to the build material particles at selected locations of the layer being solidified to form a section of a 3D object.

3. The apparatus of claim 1, wherein the first stereoscopic 3D image and the second stereoscopic 3D image are captured following the build material particles at selected locations of the layer being solidified to form a second of a 3D object and while the build material particles are undergoing cooling.

4. The apparatus of claim 1, wherein the instructions are further to cause the processor to:
determine whether the layer includes a defective area from the 3D deformation map of the layer surface; and
implement the action based on a determination that the layer surface includes a defective area.

5. The apparatus of claim 1, wherein the action includes at least one of outputting an alert, stopping a forming operation of a 3D object, or modifying a forming operation on a subsequently deposited layer of build material particles.

6. The apparatus of claim 1, wherein the instructions are further to cause the processor to:
access a third stereoscopic 3D image of a surface of a second layer of build material particles, the second layer of build material particles being deposited on the layer of build material particles;
generate a second 3D deformation map of the second layer surface from the third stereoscopic 3D image of the second layer surface; and
identify a characteristic of the second layer from an analysis of the 3D deformation map and the second 3D deformation map.

7. The apparatus of claim 6, wherein the instructions are further to cause the processor to:
based on the identified characteristic of the second layer, at least one of:
output an alert;
stop a forming operation of a 3D object; or
modify a forming operation of the 3D object on a subsequently deposited layer of build material particles.

8. A method comprising:
accessing, by a processor, a first stereoscopic three-dimensional (3D) image of a surface of a first layer of build material particles;
accessing, by the processor, a second stereoscopic 3D image of a surface of second layer of build material particles, the second layer being deposited on the first layer;
generating, by the processor, a 3D deformation map of the second layer surface from the second stereoscopic 3D image and the first stereoscopic 3D image;
identifying, by the processor, a characteristic of the second layer from the 3D deformation map; and
outputting, by the processor and based on the identified characteristic of the second layer, an instruction to at least one of issue an alert or modify a forming operation of a 3D object.

9. The method of claim 8, wherein outputting the instruction further comprises:
at least one of:
outputting an instruction to issue an alert;
outputting an instruction to stop the forming operation of the 3D object; or
outputting an instruction to modify the forming operation of the 3D object on at least one of the second layer or a subsequently deposited layer.

10. The method of claim 8, wherein the first stereoscopic 3D image is captured following build material particles in selected locations of the first layer being joined together, the method further comprising:
generating a 3D deformation map of the first layer surface from the first stereoscopic 3D image; and
comparing the 3D deformation map of the second layer surface with the 3D deformation map of the first layer surface to identify the characteristic of the second layer.

11. The method of claim 8, wherein the second stereoscopic 3D image is captured prior to fusing energy being applied to build material particles in selected areas of the second layer, the method further comprising:
modifying a forming operation of the build material particles on the second layer based on the identified characteristic of the second layer.

12. The method of claim 11, wherein the identified characteristic is a density of the build material particles in the second layer, the method further comprising:
modifying the forming operation based on the identified density of the build material particles on the second layer.

13. The method of claim 8, wherein the second, the method further comprising:
accessing a third stereoscopic 3D image of the surface of the second layer of build material particles, the second stereoscopic 3D image and the third stereoscopic 3D image being captured following fusing energy being applied onto the second layer and while the build material particles in the second layer are cooling;
generating a second 3D deformation map of the second layer surface from the second stereoscopic 3D image and the third stereoscopic 3D image; and
wherein identifying the characteristic of the second layer further comprises identifying the characteristic of the second layer from the second 3D deformation map.

14. A three-dimensional (3D) fabrication system comprising:
a spreader;
forming components; and
a processor to:
control the spreader to spread build material particles into a first layer;
control the forming components to join build material particles in selected areas of the first layer;
access a first stereoscopic 3D image of a surface of the first layer following joining of the build material particles;
access a second stereoscopic 3D image of the first layer surface, the second stereoscopic 3D image being captured at a later time than the first stereoscopic 3D image;
generate a 3D deformation map of the first layer surface from the first stereoscopic 3D image and the second stereoscopic 3D image; and
implement an action based on the generated 3D deformation map of the first layer surface.

15. The 3D fabrication system of claim 14, wherein the processor is further to:
control the spreader to spread build material particles into a second layer;
access a third stereoscopic 3D image of a surface of the second layer;
generate a second 3D deformation map of the second layer surface from the third stereoscopic 3D image of the surface layer;
identify a characteristic of the second layer from an analysis of the 3D deformation map and the second 3D deformation map of the second layer surface; and
implement a second action based on the generated second 3D deformation map of the second layer surface.
